(19) United States
(12) Patent Application Publication
(10) Pub. No.: US 2014/0229201 A1
(43) Pub. Date: Aug. 14, 2014

(54) Computer Systems and Computer-Implemented Methods for Providing an Investment Product Having Withdrawal Benefits

(71) Applicants: James A. Mallon, Stowe, VT (US); Grace D. Harvey, Cary, NC (US); Rodney E. Rishel, JR., Nashville, TN (US)

(72) Inventors: James A. Mallon, Stowe, VT (US); Grace D. Harvey, Cary, NC (US); Rodney E. Rishel, JR., Nashville, TN (US)

(21) Appl. No.: 13/764,626

(22) Filed: Feb. 11, 2013

(51) Int. Cl. G06Q 40/08

(52) U.S. Cl. CPC G06Q 40/08
USPC 705/4

(57) ABSTRACT

Methods, systems, and devices of administering investment products, such as investment products with withdrawal benefits, are provided.

### FIELD OF INVENTION

The present invention relates generally to computer systems that are configured for use in the financial services field, and more particularly, but not by way of limitation, to computers that are configured for processing data related to investment products, such as life insurance policies.

### BACKGROUND

In the investment products market, there exists a variety of offerings that provide for retirement planning, such as life insurance policies, annuities, and mutual funds that allow for periodic payments to be made to an individual later in life. For example, in the field of life insurance, certain life insurance policies make available to the owner the option to sell his or her interest in a life insurance policy to obtain some portion of the death benefit as immediate income prior to death of the insured. In some instances, policy owners may sell their interest to third parties who agree to take on premium payments in exchange for all, or part, of the death benefits. In other instances, insurers offer programs under which portions of death benefits may be exchanged for immediate income.

### SUMMARY

This disclosure includes embodiments of computer systems, computer-implemented methods, and computer-readable media configured to process data related to an investment product, such as a permanent life insurance policy having a death benefit.

More specifically, this disclosure includes embodiments of computer systems that comprise a data storage device and a processor configured to determine whether, in light of one or more factors, an investment product owner is eligible to receive one or more withdrawal benefit payments. The processor makes this determination without resorting to (and, more specifically, without processing) data indicative of a minimum age of the insured that would otherwise be tied to withdrawal benefit payment eligibility.

Some embodiments of the present computer systems comprise a data storage device storing certain data. In some specific embodiments, the data is indicative of an owner of an investment product having a death benefit; an insured under the investment product; a death benefit amount payable under the investment product to a beneficiary upon death of the insured; a guaranteed withdrawal benefit percentage; a withdrawal benefit basis; a continuation guarantee target date; a schedule of withdrawal benefit factors; a withdrawal benefit balance; and/or a continuation guarantee account value.

Some embodiments of the present computer systems also comprise a processor in communication with the data storage device. In some specific embodiments, the processor is configured to determine a current continuation guarantee account value. In some specific embodiments, the processor is configured to make the determination based on at least any premium payments received, any charges based on policy face value, any interest credited on balances, and/or any charges based on any riders.

In some more specific embodiments, the processor is also configured to, based on certain data, determine whether the continuation guarantee account value on or after the target initial election date will be depleted prior to the continuation guarantee target date. In some specific embodiments, the determination described in this paragraph is made assuming no premium payments are paid on or after the target initial election date. In some specific embodiments, the determination in this paragraph is made based on at least the current continuation guarantee account value, a schedule of premium payments, and a target initial election date.

Some embodiments of the present computer systems provide an output signal indicative of the determination of whether the continuation guarantee account value will be depleted prior to the continuation guarantee target date. In some specific embodiments, the processor is configured to output this signal.

In another respect, this disclosure includes embodiments of computer-implemented methods for processing data related to an investment product having a death benefit. Embodiments of the methods are directed to determining, at least in part, whether, in light of one or more factors, an investment product owner is eligible to receive one or more withdrawal benefit payments. Such determination is made without resorting to (and, more specifically, without processing) data indicative of a minimum age of the insured that would otherwise be tied to withdrawal benefit payment eligibility.

Some embodiments of the present computer-implemented methods comprise accessing by a processor from a data storage device certain data associated with a financial product. In some specific embodiments, the data is indicative of a continuation guarantee account value; a schedule of withdrawal benefit factors; a target initial election date; and/or a continuation guarantee target date.

Some embodiments of the present computer-related methods comprise determining by the processor, based on certain data, whether the continuation guarantee account value on or after the target initial election date will be depleted prior to the continuation guarantee target date. In some specific embodiments, the determination described in this paragraph is made assuming no premium payments are paid on or after the target initial election date. In some specific embodiments, the determination in this paragraph is made based on at least the current continuation guarantee account value, a schedule of premium payments, and a target initial election date.

Some embodiments of the present computer-related methods comprise providing an output signal indicative of the determination of whether the continuation guarantee account value will be depleted prior to the continuation guarantee target date. In some specific embodiments, the processor is configured to output this signal.

In another respect, this disclosure includes embodiments of non-transitory computer-readable media. The media have computer- (and, more specifically, processor-) executable instructions stored thereon that, when executed by the computer (and, more specifically, processor) cause the processor to determine, at least in part, whether, in light of one or more factors, an investment product owner is eligible to receive one or more withdrawal benefit payments. Such determination is made without resorting to (and, more specifically, without processing) data indicative of a minimum age of the insured that would otherwise be tied to withdrawal benefit payment eligibility.

Some embodiments of the present computer-readable media comprise processor-executable instructions stored thereon that, when executed by the processor, cause the processor to access certain data from a data storage device. In some specific embodiments, the data is indicative of a continuation guarantee account value; a schedule of withdrawal benefit factors; a target initial election date; and/or a continuation target date.

Some embodiments of the present computer-readable media also comprise processor-executable instructions stored thereon that, when executed by the processor, cause the processor to determine a current continuation guarantee account value. In some specific embodiments, the determination described in this paragraph may be based on at least any premium payments received, any charges based on policy face value, any interest credited on balances, and/or any charges based on any riders.

Some embodiments of the present computer-readable media also comprise processor-executable instructions stored thereon that, when executed by the processor, cause the processor to determine, based on certain data, whether the continuation guarantee account value on or after the target initial election date will be depleted prior to the continuation guarantee target date. In some specific embodiments, the determination described in this paragraph is made assuming no premium payments are paid on or after the target initial election date. In some specific embodiments, the determination in this paragraph is made based on at least the current continuation guarantee account value, a schedule of premium payments, and a target initial election date.

Some embodiments of the present computer-readable media also comprise processor-executable instructions stored thereon that, when executed by the processor, cause the processor to output a signal indicative of the determination of whether the continuation guarantee account value will be depleted prior to the continuation guarantee target date.

Any embodiment of any of the computer systems, computer-implemented methods, and computer-readable media can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic diagram of an exemplary computer system for implementation of embodiments of the present methods and systems.

FIG. 2 is a schematic diagram of an exemplary computer hardware server with networked devices for implementation of embodiments of the present methods and systems.

FIG. 3 is a schematic diagram of an exemplary computer server and process flow diagram for implementation of embodiments of the present methods and systems.

FIG. 4 is a schematic diagram of an exemplary computer server and process flow diagram for implementation of embodiments of the present methods and systems.

FIG. 5 provides a timeline showing an embodiment in which the insured is the owner of the policy and collects withdrawal benefits, depleting the death benefit.

FIG. 6 illustrates a timeline showing an embodiment in which the insured is not the owner of the policy, and the owner collects the withdrawal benefit.

FIG. 7 illustrates a timeline showing an embodiment in which the withdrawal benefit is less than the entire death benefit, and is depleted prior to the death of the insured.

### DETAILED DESCRIPTION

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified, as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a system, element of a system, software module, or the like that is configured in a certain way is configured in at least that way, but it can also be configured in other ways than those specifically described.

It is to be understood that the figures and descriptions have been simplified to illustrate elements that are relevant for a clear understanding of the present embodiments, while eliminating, for the purpose of clarity, many other elements found in typical computer systems and methods for processing of data relating to insurance. Those of ordinary skill in the art may recognize that other well-known elements and/or steps are desirable and/or required in implementing the present embodiments.

### DEFINITIONS

Initial specified amount/specified amount—the total benefits that may be paid out under the policy, whether as a death benefit, or as withdrawal benefits.

Withdrawal benefit basis percentage—a percentage of the initial specified amount elected by the policy owner representing the withdrawal benefit basis. For example, if the initial specified amount is $1,000,000 and the owner elects a withdrawal benefit basis percentage of 50%, the withdrawal benefit basis would be $500,000.

Withdrawal benefit basis—a value calculated by multiplying the initial specified amount by the withdrawal benefit basis percentage.

Withdrawal benefit balance—the remaining amount of withdrawal benefits available under a policy. In some embodiments, to determine the initial withdrawal benefit balance, a processor multiplies the withdrawal benefit basis by an applicable withdrawal benefit factor shown on the rider schedule or policy. The initial value for this amount (termed the “initial withdrawal benefit balance”) is set on the election date and is used to determine the guaranteed withdrawal benefit under the rider schedule or policy. In some embodiments, the initial withdrawal benefit balance is determined on the initial election date as the withdrawal benefit basis on the initial election data multiplied by the applicable withdrawal benefit factor shown on the rider schedule or policy.

Withdrawal benefit factor—a factor that may vary by risk class, gender, and duration since the date of issue of the policy or rider (this factor varies based on the policy year that the benefit is initially elected). The withdrawal benefit factor may be a table of values that is displayed on the policy or rider schedule.

Guaranteed withdrawal benefit—the amount of withdrawal benefits that can be paid out to the policy owner on a monthly basis.

Minimum eligibility period—a minimum period that a policy must have been in force prior to payment of withdrawal benefits.

Withdrawal benefits—payments made to a policy owner prior to death of the insured.

Initial election date—a date specified by a policy owner on which they elect to begin receiving withdrawal benefits. Withdrawal benefits may commence following the initial election date provided requirements set in the policy or rider are met.

Target initial election date—a date specified by a policy owner on which they elect to begin receiving withdrawal benefits. Withdrawal benefits may commence following the target initial election date provided requirements set in the policy or rider are met. In some embodiments a target initial election date may become an initial election date, or authorized initial election date once requirements set in the policy or rider are met.

Death benefit—benefits paid to the beneficiary upon death of the insured.

Continuation guarantee account—a guarantee account associated with a life insurance policy. The value of a continuation guarantee account may be determined based on premiums received, or a portion/percentage of premiums received to date, interest equal to interest at a credited rate, and deductions, such as fees, finance charges, maintenance charges and the like. The value of a continuation guarantee account may also depend on a prior value of the continuation guarantee account, such that the value of the continuation guarantee account is calculated on a periodic basis with premium payments over the prior period, interest over the prior period, and deductions for the prior period being factors in the value of the continuation guarantee account. The value of the continuation guarantee account may be calculated on a monthly period. Alternatively, the value of the continuation guarantee account may be calculated on other periods, such as weekly periods, quarterly periods, bi-yearly periods, or yearly periods. The value of the continuation guarantee account associated with the life insurance policy may also be decremented by the amount of withdrawal benefit payments made to the policy owner.

A challenge faced by individuals performing retirement planning is a risk that the income provided by a retirement plan will be depleted during the individual's lifetime. A retirement plan may be designed to provide a certain level of income to an individual through a particular age; for example, a financial planner may provide a financial plan that provides an income through age 85 or 90. Any balance of assets upon death of the individual may be passed to the heirs. However, the individual may live past the age at which their financial plan can provide an income, leaving them with insufficient assets.

Embodiments of the present systems and methods involve an investment product, such as a life insurance policy or an annuity product. In one embodiment, the investment product is a life insurance policy that has a death benefit. The policy, for example, may be a universal, variable life or whole life insurance policy. The policy may be another type of permanent life insurance policy. A permanent life insurance policy remains in force for the full life of the insured, subject to payment of required premiums and meeting of any other conditions. In contrast, a term life policy remains in force for a period of years.

In some embodiments, the permanent life insurance policy includes a benefit, in the nature of a withdrawal benefit. The withdrawal benefit allows the owner to receive periodic payments from the insurance company if the insured so elects and if certain defined conditions have been met. Upon payment, the amount of the death benefit is reduced. According to some embodiments of the invention, the payments continue and the death benefit amount is reduced until a residual or minimum death benefit value is reached. This minimum death benefit value may be established or calculated as a percentage of the policy face value, for example, and may be determined in accordance with applicable regulatory definitions of life insurance.

In certain embodiments, the payment amount is a proportionate amount of the “initial withdrawal benefit balance,” which is the death benefit available for withdrawal as a withdrawal benefit when the payments start. For example, each payment may be a value such as: 0.5 percent, 0.83%, 1%, 1.5%, 2.0%, or 2.5% on a monthly basis; 5%, 9.96%, 10% or 15% on an annual basis; or another value within the ranges of those values. The monthly and annual payment periods are merely exemplary, and payments may be on another basis, such as weekly, once every two weeks, twice each month, once each calendar quarter, or another period.

The owner may have the option of receiving the benefits or declining the benefit payments and maintaining the death benefit unchanged.

In some embodiments, the benefit is implemented in a rider to an insurance policy. In some more specific embodiments, the rider must be purchased at the time of issue of the policy. In other embodiments, the rider may be purchased after issue of the policy and up to a certain age of the insured, such as an age in the range of 55 to 70.

In some embodiments, after a final withdrawal benefit payment is made, the policy may continue in effect, and a death benefit amount may remain to be paid to a beneficiary.

In some embodiments, a life insurance policy may have a guarantee account, such as a continuation guarantee account, associated therewith.

As mentioned previously, the ability to receive withdrawal benefits depends upon certain conditions being met. For example, one condition could be that the withdrawal benefits under the life insurance policy may be available on condition that the policy is fully paid up. Another condition could be that the policy has been in force for at least a minimum eligibility period shown on the policy or rider. In some embodiments, this minimum eligibility period may be 15 years, 40 years, or another term, which may be listed on the policy or rider. Yet another condition could be that the guarantee account, such as the continuation guarantee account, associated with the policy has a certain minimum value as of an initial election date chosen by the policy owner. In some embodiments, this minimum value may be determined once, such as prior to the initiation of withdrawal benefit payments under the policy or rider. Withdrawal benefit payments may be denied if the continuation guarantee account does not have a value exceeding the certain minimum value.

In some embodiments, the minimum value of the continuation guarantee account may be based on a continuation target date. The minimum value may be determined by obtaining the current value of the continuation guarantee account; calculating the periodic withdrawal benefit to be paid under the policy; determining the number of payments that can be made between the election date and the continuation target date; and determining whether, assuming no future premium payments are received, the continuation guarantee account value will remain positive through the continuation target date assuming all possible withdrawal benefits are to be paid through the continuation date. If the determination is made that withdrawal benefit payments made though the continuation target date will not reduce the value of the continuation guarantee account to below zero on or before the continuation target date, then withdrawal benefit payments may be authorized to commence.

In some embodiments, the minimum value of the continuation guarantee account may be based on a continuation target date. The minimum value may be determined by obtaining the current value of the continuation guarantee account based on at least any premium payments received, any charges based on policy face value, any interest credited on balances and any charges based on riders. A determination based on at least the current continuation guarantee account value, a schedule of premium payments, and a target initial election date may be made as to whether the continuation guarantee account value on or after the target initial election date will be depleted prior to the continuation guarantee target date assuming no premium payments are paid on or after the target initial election date. A signal may be output indicative of whether the continuation guarantee account will be depleted prior to the continuation guarantee target date.

The continuation target date may be selected to correspond to the age of the insured and may be set at the anniversary of the insured's reaching 100 years old, 95 years old, 90 years old, or another age-related target date. Alternatively, in some embodiments, the continuation target date may be determined according to a set period of time, such as 20, 25, 30, 35, 40, or 45 years from the initial election date.

Setting a continuation target date based on an age, such as 100 years, but allowing an initial election date not dependent on age of the insured or of the policy owner, permits flexibility on the part of the policy owner such that they may begin receiving payments as soon as they have made sufficient premium payments to guarantee continuation of the life insurance policy to the continuation target date. Such flexibility may be desirable to potential policy owners who desire flexibility to choose to begin receiving withdrawal benefits when needs arise, whether or not they have achieved a particular age.

Some embodiments of the present systems may be configured to determine, on a periodic basis, whether a continuation guarantee account associated with an investment product, such as a particular life insurance policy, has attained a value sufficient to permit the policy owner to elect to begin receiving withdrawal benefits. The system may also be configured to provide notification to the policy owner when such a determination has been made, or of the results of such a determination. Some embodiments of the present systems may be configured to also determine a projected future date on which the continuation guarantee account will have achieved sufficient value to permit the election to begin receiving withdrawal benefits, assuming premium payments continue according to previous payment habits, or according to a predetermined premium payment schedule. The system may also be configured to include the projected date in a notification to the policy owner. The notifications may be periodic, such as annually, and may be more frequent as the value of the continuation guarantee account increases.

As used herein, a module of executable code may, for instance, comprise one or more physical or logical blocks of computer instructions that may, for instance, be organized as an object, procedure, process, or function. Nevertheless, the executables of an identified module need not be physically located together, but may comprise separate instructions stored in different locations that, when joined logically together, comprise the module and achieve the stated purpose for the module, such as implementing the relevant functions described herein. A module of executable code may be a compilation of many instructions, and may even be distributed over several different code partitions or segments, among different programs, and across several devices. Similarly, data, including by way of example policy data, insured data, and investment data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

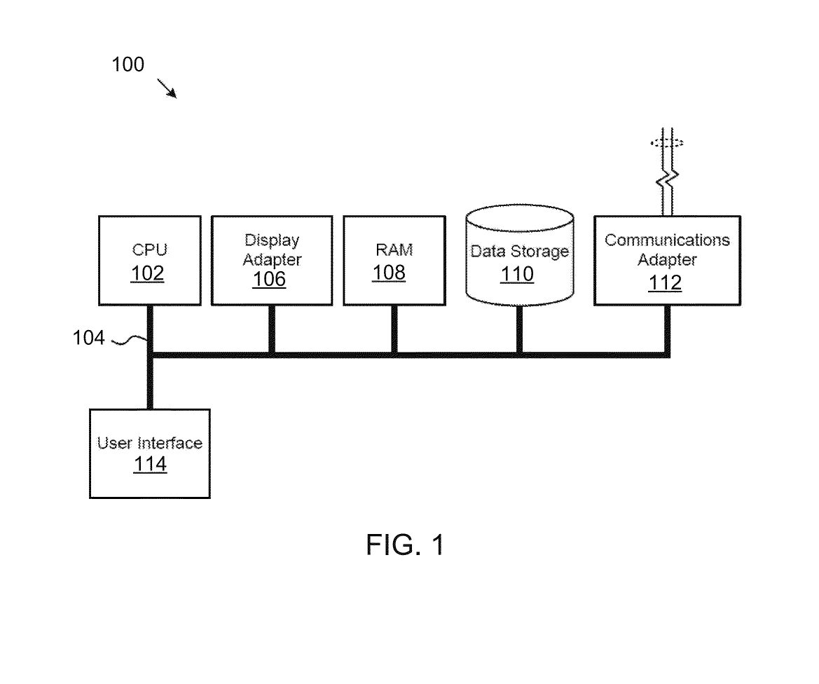

FIG. 1 shows one embodiment of the present computer systems that may be used to perform embodiments of the present methods. Computer system 100 includes a processor 102, such as central processing unit (CPU), that is capable of executing computer instructions. The processor 102 is coupled to a bus 104 that carries information between different modules or components within computer system 100. Display adapter 106 is also connected to the bus 104 and is capable of displaying graphics. Random access memory (RAM) 108 is also connected to bus 104. RAM is used by processor 102 to execute instructions. Data Storage 110 is connected to bus 104 and is capable of storing digital data. Digital data may include instruction code that is executed by processor 102. User interface 114 is also connected to bus 104 and allows a user to interact with the computer system 100. One example of a user interface is a keyboard (not shown). Finally, communications adapter 112 is connected to bus 104. The communications adapter may be a network card that allows computer system 100 to connect to the internet. In some embodiments, processor 102 may be a device that executes software instructions. Alternatively, processor 102 may be hard-wired to perform the functions of the disclosed methods. For example, processor 102 may be an Application Specific Integrated Circuit (ASIC) that is configured to execute the functions of the disclosed methods without the use of external software.

Data storage 110 may include local and network accessible mass storage devices. Storage 110 may include media for storing information such as insurance data and other data related to policies and insureds. Such data may include data regarding policies, insureds, owners, cash balances, guarantee accounts, and other relevant data. In some embodiments, inputs may include user interfaces 114, including workstations having keyboards, touch screens, pointing devices such as mice, or other user input devices, connected via networked communications to processor 102. Communications adapter 112 may communicate via a network with other insurance company computer systems, computer systems of brokers, financial advisors, insureds and owners, computer systems of banks and other financial institutions that effect payments of premiums under the policy and payments of benefits under the policies, remote sources of data, and with systems for implementing instructions output by processor 102.

Processor 102 (which may be at least one of the processors of computer system 100) is a special-purpose processor, and computer system 100, of which it is a part, is a special-purpose computer system, because they cannot be controlled to perform the functions described in this disclosure when purchased off-the-shelf; instead, they must be programmed (through software, hardwiring, or a combination of both) in order to perform such functions. The phrase “the processor is configured to [perform one or more functions]” means that the processor may, through program (e.g., software) instructions be controlled to perform the one or more functions, may be hard-wired to perform the one or more functions, or may, through a combination of program control and hard-wired control, be capable of performing the one or more functions. The use of a processor allows for the processing and consideration of large amounts of data that is not possible without the aid of a computer, a computer system, or a processor. Any one or more of the steps of embodiments of the present methods, may be performed (or, in the case of the present computer systems or devices, the system or device may be configured to perform any one or more of the steps or functions discussed above) within a certain amount of time, including no more than one hour, no more than 30 minutes, no more than 15 minutes, no more than 10 minutes, and no more than one minute.

Some embodiments of the present methods include converting into digital electrical signals data that is received through a machine such as a keyboard, a touch screen, a wand, a point and click device (e.g., a mouse), or another suitable input device, so that the signals can then be processed in order to carry out other steps in the respective method. The conversion may be accomplished by an input device (such as through a processor in a keyboard) or through the processor or processors that accomplish other steps of the method. The source of a given piece of information may include a local or remote database that may be accessible by the processor. In some embodiments, remote databases may be accessible through a computer network, such as the internet. Some embodiments of the present computer systems may include a machine capable (either through software control or hard wiring) of accomplishing this data conversion.

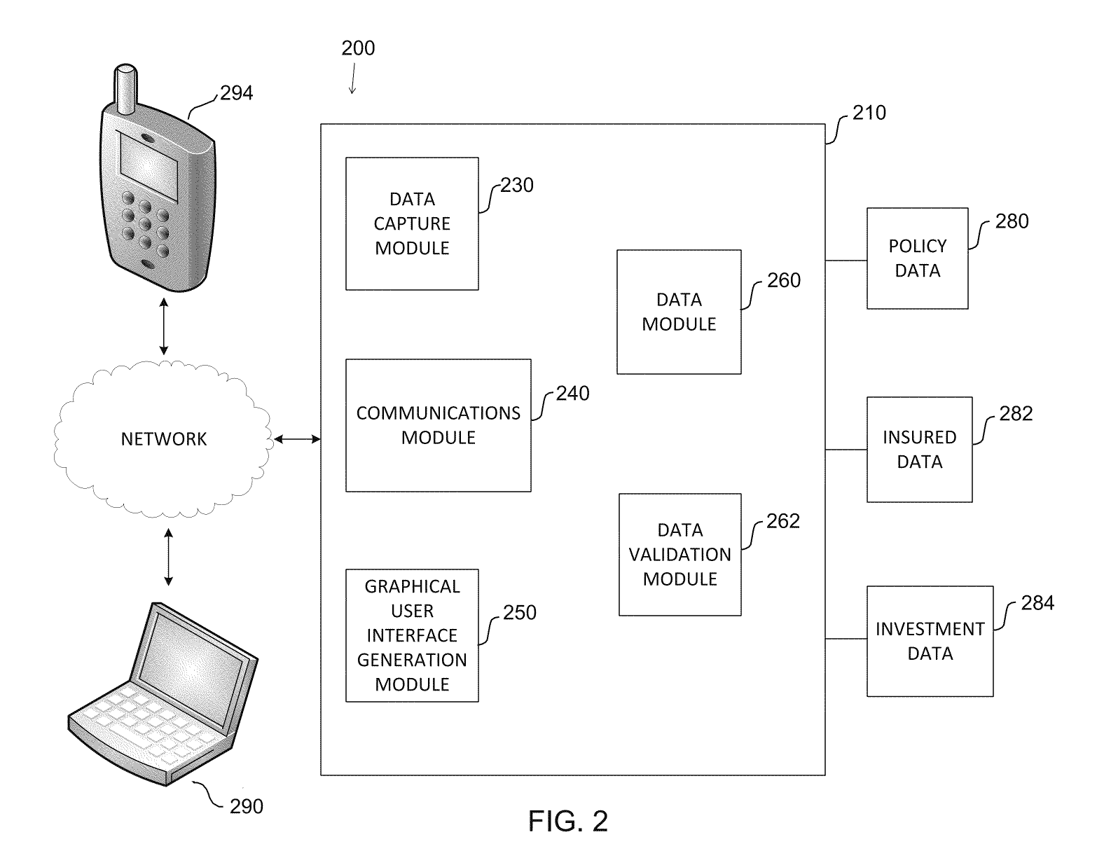

Referring now to FIG. 2, another exemplary embodiment of the present computer systems, system 200, is shown. System 200 includes a server 210 that includes one or more engines or modules that may be utilized to perform one or more of the functions disclosed herein. In some embodiments, functions are achieved using one or more modules of a computer software program in combination with one or more components of hardware. Such software programs will be used generally where a policy owner, broker, or advisor, or other representative of an owner, has sent a request for data or information to a server, and comprises part of the processing done on the server side of the network. The program may be used in an internet environment, where the server is a web server and the request is formatted using HTTP (or HTTPS). Alternatively, the server may be in a corporate intranet, and extranet, or any other type of network. The term “Internet,” when discussing processing associated with the user's request, includes these other network environments, unless otherwise stated. Additionally, a graphical user interface or insurance processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as smart phone 294, and capable of being accessed and executed by a processor of the client device.

Referring still to FIG. 2, server 210 includes a data capture or input/output module 230, a communications module 240, a dynamic display generation or graphical user interface module 250, a data module 260, and a data validation module 262. Data module 260 is in further communication with a number of databases, such as insurance policy database 280, insured database 282, and investment database 284. Databases in communication with server 210 may include both internal and/or external/third party databases. By way of example, external databases may include databases of financial services entities containing information relating to policy subaccounts and other policy investments. Server 210 may be configured for bulk upload of data for use in administration of insurance policies, such as data relating to funds in subaccounts or investors and securities, which data may be from a third party database or file. One or more modules may be configured to perform data validation steps prior to storing bulk uploaded data. Server 210 may further be configured to permit bulk download of data, such as policy and benefit data, to a client device.

In operation, server 210 is in communication with client devices, such as computer 290 or smart phone 294, via a network that facilitates interaction with server 210 through one or more graphical user interfaces as shown and described herein. As used herein, devices, such as client devices 290, 294, may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the internet, an intranet, or an extranet. Note that any devices described herein may communicate via one or more such communication networks.

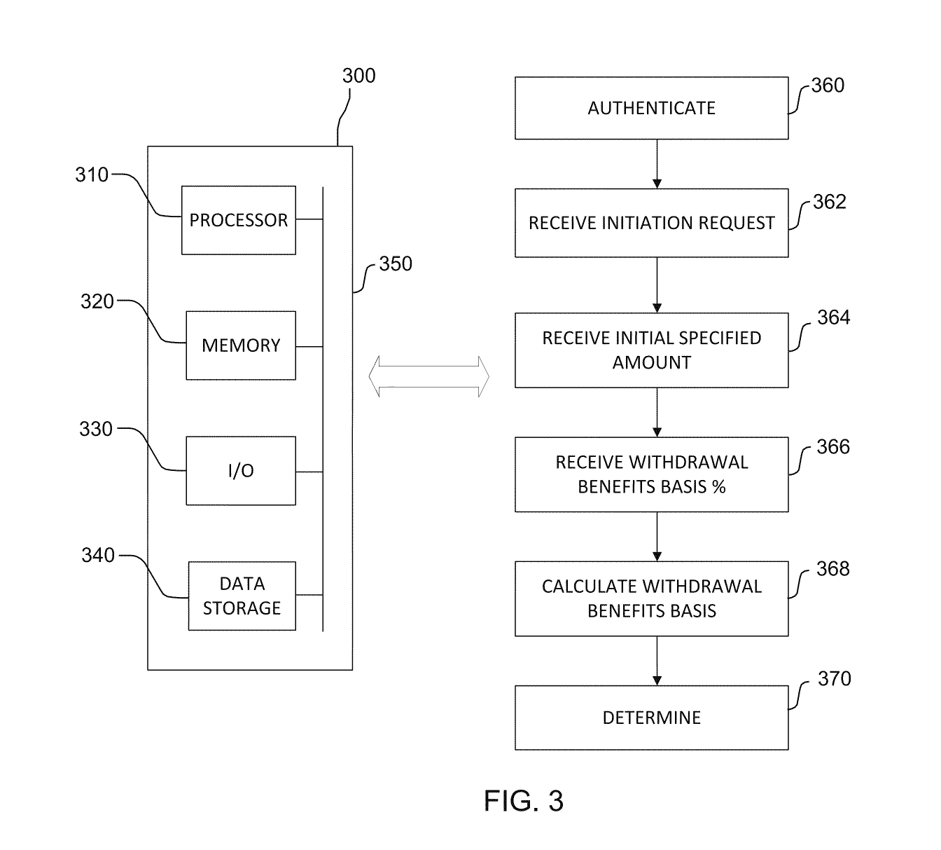

Referring to FIG. 3, in some embodiments, a computer server or client computer 300 running a client application, such as a web browser or a thick-client application, renders a graphical user interface, such as a series of input screens for viewing input from a customer or consumer. Server or client computer 300 may include a processor 310, a memory 320, I/O interface 330, and a storage mechanism 340 coupled together via a system bus 350 over which the various elements may interchange data and information. Computer 300 can implement steps in accordance with some embodiments of the present systems and methods.

Still referring to FIG. 3, at 360, computer 300 receives authentication information from an authorized user, such as a policy owner or representative of a policy owner, and authenticates the user. At 362, the system (which comprises at least computer 300) receives from the user a request to initiate a policy or policy rider providing the option of receiving withdrawal benefits. At 364, the system also receives from the user an initial specified amount of benefits. The initial specified amount represents the total benefits that may be paid out under the policy, whether as a death benefit, or as withdrawal benefits. At 366, the system then receives from the user a withdrawal benefit basis percentage. The system may require that the withdrawal benefit basis percentage meet certain requirements, such as that the withdrawal benefit basis percentage be a whole number. At 368, the system (and, more specifically, as those of ordinary skill in the art will understand in this and other instances involving system operation, the processor 310 or processors of the system) determines (e.g., calculates) a withdrawal benefit basis using the withdrawal benefit basis percentage supplied by the user. The withdrawal benefit basis may be calculated by multiplying the withdrawal benefit basis percentage by the initial specified amount. For example, if a user elected an initial specified amount of $1,000,000 and a withdrawal benefit basis percentage of 50%, the withdrawal benefit basis calculated by the system may be $500,000.

At 370, the system determines whether the initial specified amount, withdrawal benefit basis percentage, and withdrawal benefit basis fall within policy/rider constraints set by the insurer. In one embodiment, the following policy and rider constraints may be stored in memory and used for determining whether the user supplied values are acceptable: the withdrawal benefit basis must be over a minimum amount (e.g., $100,000); and the withdrawal benefit basis may not exceed the policy specified amount. If requisite conditions are met, the system may output a signal indicative of policy/rider issuance and a message may be provided to the user indicating coverage.

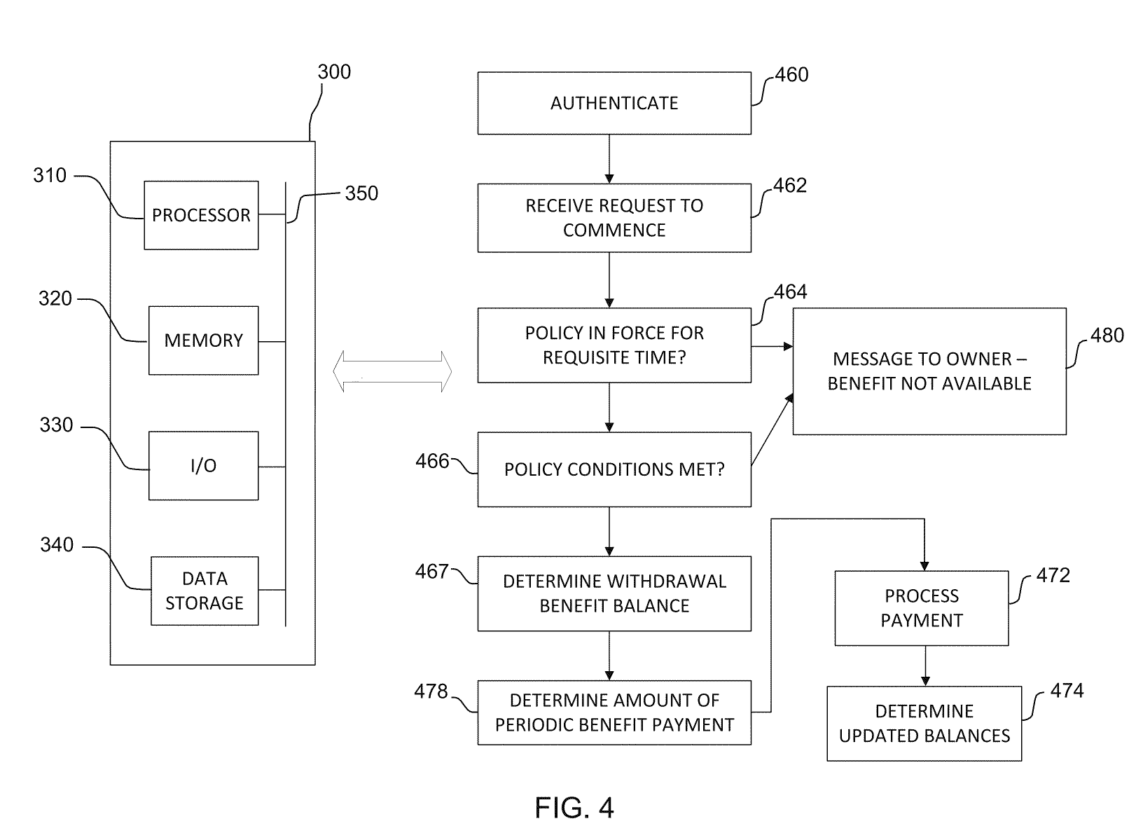

Referring to FIG. 4, in some embodiments, computer 300 receives, at 460, authentication information from an authorized user, such as a policy owner or representative of a policy owner, and authenticates the user. At 462, the system (which comprises at least computer 300) receives from the user a request to commence benefit payments on an initial election date. At 464, the system may determine (e.g., by accessing data storage 340) whether the policy has been in force for a requisite period of time, such as 15 years. If the policy has not been in force for the requisite period of time, at 480, the system outputs a communication to the owner that benefits are not presently available. If, instead, the policy has been in force for the requisite period then, at 466, processor 310 (or the processors) of the system may access rules and data to determine whether other policy conditions are met for payment of the withdrawal benefit. Those policy conditions may include whether the policy is paid up, if that is a condition under the policy. If the system determines that the conditions have not been met, then the system may output a signal indicative of a message to the owner that the benefit is not available. If the system determines that the policy conditions have been met, then, at 467, the system may determine the withdrawal benefit balance. At 478, the system may then determine the amount of each periodic benefit payment as a fraction or percentage of the withdrawal benefit balance, such as 0.83 percent of the withdrawal benefit balance as the payment for each month. At 472, the system may then output a signal indicative of instructions for a first benefit payment, such as to a payment fulfillment system that prints and mails checks, or to a system that is in communication with the insurance company's bank and can effect an electronic payment. At 474, the system may determine updated benefit balances and other policy values. The system may cause a statement to be generated, and printed and mailed to an owner, made available on a secure website or other electronic resources, e-mailed or otherwise delivered.

In some embodiments, determining whether policy conditions are met, at 466, involves a one-time determination of whether the value of the policy continuation guarantee account is sufficient. To determine whether the value of the continuation guarantee account is sufficient, a withdrawal benefit balance is determined on the initial election date. To determine the initial withdrawal benefit balance, the system multiplies the withdrawal benefit basis by the applicable withdrawal benefit factor shown on the rider schedule or policy.

Once an initial withdrawal benefit balance is determined, a guaranteed withdrawal benefit is calculated on the initial election date. The guaranteed withdrawal benefit is determined as the guaranteed withdrawal benefit multiplied by a value such as 0.5 percent, 0.83%, 1%, 1.5%, 2.0%, or 2.5% of the initial withdrawal benefit balance

Once the guaranteed withdrawal benefit is determined, determination of whether the continuation guarantee account value is sufficient may proceed. The minimum value of the continuation guarantee account is based on a continuation target date, and the minimum value may be determined as described above. In some embodiments, the continuation target date is selected as the anniversary date that the insured attains age 100.

In some embodiments, determining whether policy conditions are met, at 466, involves a one-time determination of whether the continuation guarantee account has a minimum value based on a continuation target date. The minimum value may be determined by obtaining the current value of the continuation guarantee account based on at least any premium payments received, any charges based on policy face value, any interest credited on balances and any charges based on riders. A determination based on at least the current continuation guarantee account value, a schedule of premium payments, and a target initial election date may be made as to whether the continuation guarantee account value on or after the target initial election date will be depleted prior to the continuation guarantee target date assuming no premium payments are paid on or after the target initial election date. A signal may be output indicative of whether the continuation guarantee account will be depleted prior to the continuation guarantee target date.

In some embodiments, a target initial election date may become an initial election date, or authorized initial election date, responsive to the output indicative of whether the continuation guarantee account will be depleted prior to the continuation guarantee target date.

In some embodiments, the computer 300 may, responsive to determining that policy conditions have not been met, determine, based on scheduled premium payments, determine an election date in the future on which policy conditions will be met, making that future election date a valid future initial election date. The computer 300 may communicate the future date to a policy owner, agent, representative or broker.

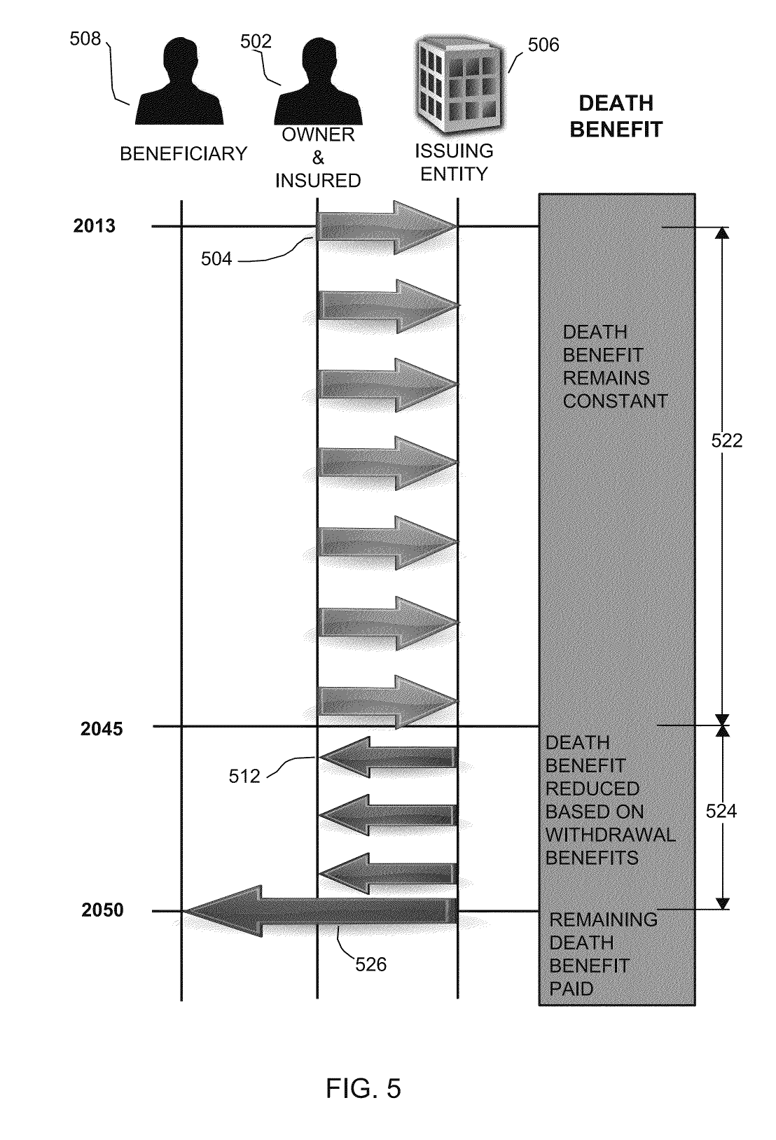

Referring to FIG. 5, a timeline is provided showing an embodiment in which the insured is the owner of the policy and collects the withdrawal benefit, depleting the death benefit. At the time of policy issue, shown here as 2013, the owner 502 commences payment of premiums 504 to issuing entity 506. The owner may have an age of 55 at policy issue in 2013. The policy designates a beneficiary 508, who will receive the death benefit under the policy upon death of the insured 502. The owner 502 continues to pay premiums 504 to issuer 506. At the year 2045, owner 502 requests withdrawal benefit payments 512. A determination of sufficient value of the continuation guarantee account is made, and if the value of the continuation guarantee account is sufficient, the withdrawal benefit payments 512 are made by issuer 506 to owner 502. During period of time, or portion, 522, the death benefit remained level or constant. During period of time, or portion 524, which starts with commencement of withdrawal benefit payments 512, the amount of the death benefit is reduced (e.g., gradually). Each withdrawal benefit payment 512 reduces the amount of the death benefit, the withdrawal benefit balance, and the continuation guarantee account value. The withdrawal benefit payments 512 continue until the death of the insured or until the amount of the withdrawal benefits exhausts the withdrawal benefit balance. The withdrawal benefit payments 512 then cease, at which point a residual death benefit, shown at 526, is determined and maintained as a level death benefit. Upon the death of the insured 502 in 2050, a death benefit 516 is paid by issuer 506 to beneficiary 508. The amount of the death benefit 516 is equal to the residual death benefit 526. The residual death benefit may be determined based on a formula, such as the remainder of the initial specified amount minus withdrawal benefits paid.

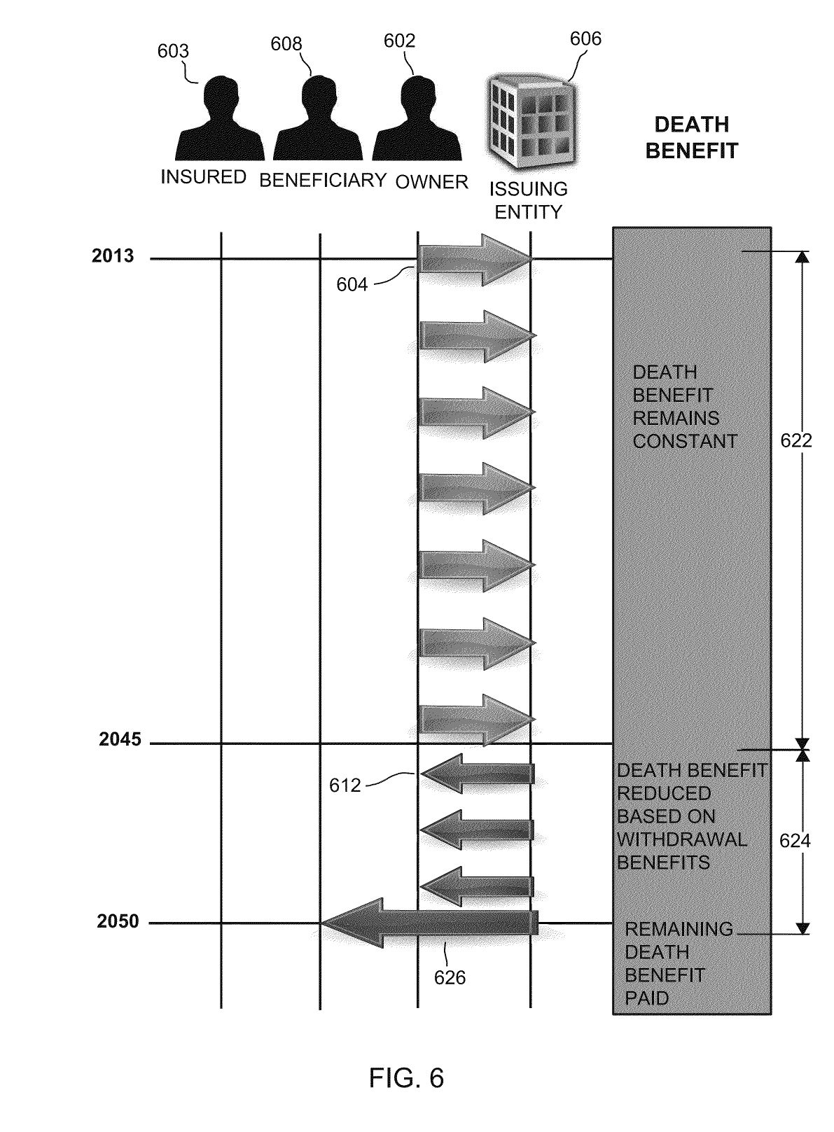

Referring to FIG. 6, a timeline is provided showing an embodiment in which the insured is not the owner of the policy, and the owner collects the withdrawal benefit until the death of the insured. By way of example, the owner and the insured may be spouses. At the time of policy issue, shown here as 2013, the owner 602 commences payment of premiums 604 to issuing entity 606. The insured 603 may have an age of 55 at policy issue in 2013. The policy designates a beneficiary 608, who will receive the death benefit under the policy upon death of the insured. The owner 602 continues to pay premiums 604 to issuer 606. At the year 2045, owner 602 requests withdrawal benefit payments 612. A determination of sufficient value of the continuation guarantee account is made, and if the value of the continuation guarantee account is sufficient, the withdrawal benefit payments 612 are made by issuer 606 to owner 602. During period of time, or portion, 622, the death benefit remained level. During period of time, or portion 624, which starts commencement of withdrawal benefit payments 612, the amount of the death benefit reduced (e.g., gradually). Each withdrawal benefit payment 612 reduces the amount of the death benefit, the withdrawal benefit balance, and the continuation guarantee account value. The withdrawal benefit payments 612 continue until the death of the insured or until the amount of the withdrawal benefits exhausts the withdrawal benefit balance. Before the death benefit is depleted, insured 603 dies, in 2050. Upon death of insured 603, the remaining death benefit 626 is paid to beneficiary 608. No further withdrawal benefit payments are made after the death of insured 603.

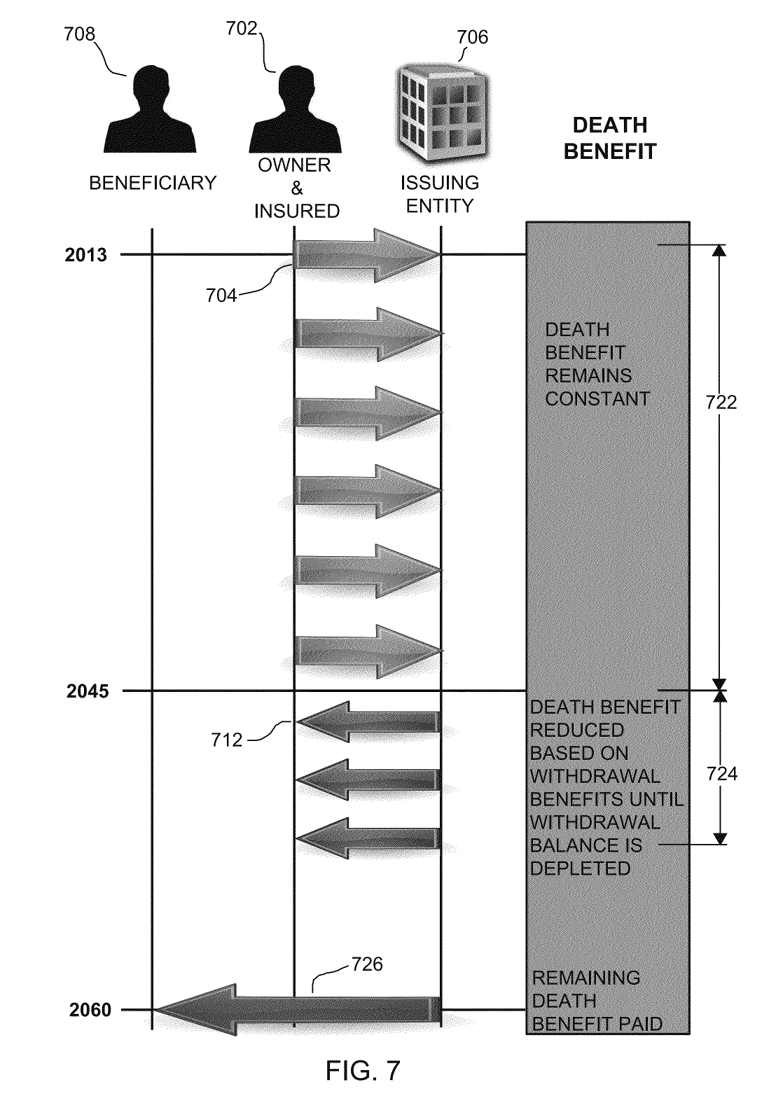

Referring to FIG. 7, a timeline is provided showing an embodiment in which the withdrawal benefit is less than the entire death benefit, and is depleted prior to the death of the insured. At the time of policy issue, shown here as 2013, the owner (and the insured) 702 commences payment of premiums 704 to issuing entity 706. The policy designates a beneficiary 708, who will receive the death benefit under the policy upon death of insured 702. The owner 702 continues to pay premiums 704 to issuer 706. At the year 2045, owner 702 requests withdrawal benefit payments 712. A determination of sufficient value of the continuation guarantee account is made, and if the value of the continuation guarantee account is sufficient, the withdrawal benefit payments 712 are made by the issuing entity to owner 702. During period of time, or portion, 722, the death benefit remained level or constant. During period of time, or portion, 724, which starts with commencement of the withdrawal benefit payments, the amount of the death benefit reduced (e.g., gradually). Each withdrawal benefit payment 712 reduces the amount of the death benefit, the withdrawal benefit balance, and the continuation guarantee account value. The withdrawal benefit payments 712 continue until the amount of the withdrawal benefits exhausts the withdrawal benefit balance. The withdrawal benefit payments 712 fully deplete the withdrawal benefit balance prior to the death of insured 702. The withdrawal benefit payments cease, and the death benefit amount remains level, as indicated by the gap following period 724. In other words, no further withdrawal benefit payments are made after the depletion of the eligible amount. Upon death of insured 702, in 2060, the remaining death benefit 726 is paid to beneficiary 708.

In the foregoing examples, the monthly period of payments is exemplary. Periodic withdrawal benefits may be made on any suitable basis, such as annually, quarterly, monthly, bi-weekly or weekly.

In some embodiments, a rider may provide the owner the option to elect to receive guaranteed withdrawal benefits under the rider beginning on the first date that benefit eligibility requirements under the rider are met.

### Examples of Insurance Rider Features

One example of a rider that can be used or included in certain of the present embodiments may have the following features:
Guaranteed withdrawal benefits (regardless of the value of the cash surrender under the policy) beginning on the initial election date for withdrawal benefits and on each month thereafter as long as the withdrawal benefit balance under the rider is greater than zero and benefit eligibility conditions under the rider are being met.
The total amount of withdrawal benefits available (the “initial withdrawal benefit balance”) is calculated on the initial election date and will depend on a number of factors:
   The withdrawal benefit basis, which may be system-determined or specified at the time of application by the applicant. The amount selected is subject to minimum and maximum limits and is used as a starting point for determining the withdrawal benefits available. The withdrawal benefit basis on the date of issue may be calculated as: withdrawal benefit basis on date issue=initial specified amount, multiplied by the withdrawal benefit basis percentage specified by the applicant at the time of application for the rider. The withdrawal benefit basis percentage preferably is specified in whole percentages. Generally, the withdrawal benefit basis should not exceed the policy specified amount.
   An adjustment factor that will depend on the insured's risk class, gender, and the duration since the effective date of rider coverage.
The amount of withdrawal benefit that will be available each month (the guaranteed withdrawal benefit) will be set to equal the initial withdrawal benefit balance, multiplied by 0.83%.
Each withdrawal benefit paid will result in a reduction in the “specified amount” (which may also be termed the “death benefit”), the “cash surrender value,” the “cash value,” and the continuation guarantee account value of the policy. As of the initial election date, no increases to the specified amount (meaning no changes to the death benefit) will be allowed.
The Rider includes a waiver provision that will waive the amount necessary to prevent the policy from going into grace beginning on the initial election date for withdrawal benefits and while eligibility requirements under the rider continue to be met (such a provision will waive the lesser of the amount needed to provide for the monthly deduction or the amount needed so that the value of the continuation guarantee account required under the policy is met.

In some embodiments, the rider may be available on variable universal life products only. In some embodiments, the rider may be available only on certain policies, such as guarantee plus products. In some embodiments, the rider may be added to a policy only on the date of issue of the policy.

In some embodiments, the rider may be available to a variety of risk classifications/ages that include whether or not the insured uses tobacco, whether the insured has other health-related issues, and the age of the insured.

Withdrawal benefits may be payable under the rider, in some embodiments, so long as the following eligibility requirements are met:
The policy has been in force for at least the minimum eligibility period shown on the rider schedule (e.g., 15 policy years).
The policy continuation guarantee account value immediately prior to the initial election date is sufficient to provide for all continuation guarantee account monthly deductions due from the initial election date for withdrawal benefits through the continuation guarantee target date shown on the rider schedule. The continuation guarantee target date will be set to equal the anniversary date that the insured attains (e.g., age 100).
Payment of the guaranteed minimum withdrawal benefit beginning on the initial election date and each month thereafter until the withdrawal benefit balance is reduced to zero does not cause the policy to fail to meet the definition of life insurance under IRC 7702.
On the initial election date, the policy is not within a 7-pay period following a material change as defined in the policy or policy rider.
There is no indebtedness under the policy.

In this example, the guaranteed withdrawal benefit is the amount of withdrawal that is guaranteed to be available under this rider beginning on the initial election date and on each month thereafter as long as the withdrawal benefit balance has not been exhausted. The actual benefit paid can never be less than reduction in cash surrender value, if any, that results from payment of a withdrawal benefit under this rider.

Each withdrawal benefit payment made under the terms of the rider will have the following impact to values under the policy: The withdrawal benefit balance will be reduced by the same dollar amount as the amount of withdrawal benefit paid; the withdrawal benefit basis will be reduced in the same proportion as the reduction in the withdrawal benefit balance; the policy specified amount will reduced by the same dollar amount as the reduction in the withdrawal benefit basis. The accumulation value, cash surrender value, cash value, and CGA account value of the policy will be reduced in the same proportion as the reduction in the specified amount of the policy; and withdrawal benefit amounts will be available as long as benefit eligibility requirements are being met and the withdrawal benefit balance is greater than $0.

The owner may request to withdraw less than the guaranteed withdrawal benefit. A lesser withdrawal amount could extend the period for which monthly withdrawals can be taken under the rider. For example, the owner may request a suspension of monthly withdrawal benefits by sending the company a written request. Withdrawal benefits may be resumed as long as the benefit eligibility requirements are being met and the withdrawal benefit balance is greater than $0.

The guaranteed withdrawal benefit may be reset due to the payment of withdrawal death benefits. For example, the guaranteed withdrawal benefit will be reset on the next month anniversary following the date that the policy specified amount is decreased at the owner's request or a portion of the death benefit is accelerated under any withdrawal death benefit rider attached to the policy, except due to terminal illness. The guaranteed withdrawal benefit will, in this example, be reset as follows: A new withdrawal benefit basis will be calculated by taking the then current specified amount under the policy and reducing this by the difference between the specified amount and the withdrawal benefit basis immediately prior to the initial election date. The new guaranteed withdrawal benefit will be set to equal the old guaranteed withdrawal benefit, multiplied by the ratio between the new withdrawal benefit basis and the old withdrawal benefit basis. Payment of any withdrawal benefit is not subject to a surrender charge or a partial surrender charge.

In this example, if the specified amount under the policy is increased prior to the benefit eligibility date, the withdrawal benefit basis may also be increased subject to the limits in effect at the time of the increase. A new segment will be created for the increase in coverage. The premium and cost of insurance for each segment will be determined based on the insured's age and underwriting class at the time the segment is added.

In this example, if the specified amount under the policy is reduced (due to partial surrenders, requested decrease in the specified amount, or withdrawal benefit payments), the withdrawal benefit basis will also be reduced. The new withdrawal benefit basis will be equal to the remaining specified amount under the policy, minus the difference between the specified amount and the withdrawal benefit basis immediately prior to the specified amount change. If there are multiple rider segments, the withdrawal benefit basis will be recalculated separately for each segment.

The above specification and examples provide a description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A computer system comprising:
a data storage device storing data indicative of an owner of an investment product having a death benefit, an insured under the investment product, a death benefit amount payable under the investment product to a beneficiary upon death of the insured, a guaranteed withdrawal benefit percentage, a withdrawal benefit basis, a continuation guarantee target date, a schedule of withdrawal benefit factors, a withdrawal benefit balance, and a continuation guarantee account value; and
a processor in communication with the data storage device, the processor configured to:
determine a current continuation guarantee account value based on at least any premium payments received, any charges based on policy face value, any interest credited on balances, and any charges based on any riders;
determine, based on at least the current continuation guarantee account value, a schedule of premium payments, and a target initial election date, whether the continuation guarantee account value on or after the target initial election date will be depleted prior to the continuation guarantee target date assuming no premium payments are paid on or after the target initial election date; and
provide an output signal indicative of the determination of whether the continuation guarantee account value will be depleted prior to the continuation guarantee target date.

2. The computer system of claim 1, wherein the processor is further configured to, responsive to a determination that the continuation guarantee account value will not be depleted prior to the continuation guarantee target date, provide data indicative of instructions to provide a communication to the owner that the owner is eligible for the withdrawal benefit as of the target initial election date.

3. The computer system of claim 1, wherein the processor is further configured to, responsive to a determination that the continuation guarantee account value will be depleted prior to the continuation guarantee target date, provide data indicative of instructions to provide a communication to the owner that the owner is not eligible for the withdrawal benefit as of the target initial election date.

4. The computer system of claim 1, wherein the processor is configured to determine a current continuation guarantee account value further based on withdrawals from the policy.

5. The computer system of claim 1, wherein the processor is further configured to determine a continuation guarantee account value by at least:
accessing a prior continuation guarantee account value;
adding to the prior continuation guarantee account value a portion of premiums received subsequent to date of the prior continuation guarantee account value;
adding to the policy account balance interest equal to the interest at a credited interest rate on the prior continuation guarantee account value for a period subsequent to the date of the prior continuation guarantee account value; and
subtracting from the continuation guarantee account value a predetermined monthly deduction.

6. The computer system of claim 1, wherein the continuation guarantee target date is based on an age of the insured.

7. The computer system of claim 6, wherein the continuation guarantee target date is the anniversary date that the insured attains age 100.

8. The computer system of claim 1, wherein the withdrawal benefit balance is based on the withdrawal benefit basis.

9. The computer system of claim 8, wherein the withdrawal benefit balance is initially determined based on the withdrawal benefit basis multiplied by a withdrawal benefit factor.

10. The computer system of claim 8, wherein withdrawal benefit payments are based on a percentage of the withdrawal benefit basis initially calculated.

11. The computer system of claim 10, wherein the percentage is 0.23%-1.00%.

12. The computer system of claim 9, wherein the withdrawal benefit factor is based on at least one of risk class, gender, and time the policy has been in force.

13. The computer system of claim 9, wherein the computer system is configured to reduce the withdrawal benefit balance in amounts equal to withdrawal benefit payments made.

14. The computer system of claim 1, wherein withdrawal benefit payments are also conditional on the investment product being in force for at least a minimum eligibility period.

15. The computer system of claim 14, wherein the minimum eligibility period is 15 years.

16. A computer-implemented method for processing data related to an investment product having a death benefit, comprising:
accessing by a processor from a data storage device data indicative of a continuation guarantee account value;
accessing by the processor from the data storage device data indicative of a schedule of withdrawal benefit factors, a target initial election date, and a continuation guarantee target date;
determining by the processor a current continuation guarantee account value based on at least any premium payments received, any charges based on policy face value, any interest credited on balances, and any charges based on any riders;
determining by the processor, based on at least the current continuation guarantee account value, a schedule of premium payments, and a target initial election date, whether the continuation guarantee account value on or after the target initial election date will be depleted prior to the continuation guarantee target date assuming no premium payments are paid on or after the target initial election date; and
providing by the processor an output signal indicative of the determination of whether the continuation guarantee account value will be depleted prior to the continuation guarantee target date.

17. The computer-implemented method of claim 16, further comprising, responsive to determining that the continuation guarantee account value will not be depleted prior to the continuation guarantee target date, provide data indicative of instructions to provide a communication to the owner that the owner is eligible for the withdrawal benefit as of the target initial election date.

18. The computer-implemented method of claim 16, wherein the processor, responsive to determining that the continuation guarantee account value will be depleted prior to the continuation guarantee target date, provides data indicative of instructions to provide a communication to the owner that the owner is not eligible for the withdrawal benefit as of the target initial election date.

19. The computer-implemented method of claim 16, wherein the processor determines a current continuation guarantee account value further based on data indicative of withdrawals from the policy.

20.-30. (canceled)

31. A non-transitory computer-readable medium, the computer-readable medium having processor-executable instructions stored thereon, which instructions, when executed by the processor, cause the processor to:
access from a data storage device data indicative of a continuation guarantee account value;
access from the data storage device data indicative of a schedule of withdrawal benefit factors, a target initial election date, and a continuation target date;
determine a current continuation guarantee account value based on at least any premium payments received, any charges based on policy face value, any interest credited on balances, and any charges based on any riders;
determine, based on at least the current continuation guarantee account value, a schedule of premium payments, and a target initial election date, whether the continuation guarantee account value on or after the target initial election date will be depleted prior to the continuation guarantee target date assuming no premium payments are paid on or after the target initial election date; and
provide an output signal indicative of the determination of whether the continuation guarantee account value will be depleted prior to the continuation guarantee target date.

32.-45. (canceled)
